(19) United States
(12) Patent Application Publication
(10) Pub. No.: US 2012/0218592 A1
(43) Pub. Date: Aug. 30, 2012

(54) TEMPORARILY MODIFYING PRINT ELIGIBILITY FOR PRINT JOBS WHEN JOBS ARE FORCED TO PRINT

(76) Inventors: Dennis Carney, Louisville, CO (US); Charles D. Johnson, Boulder, CO (US); David Julie, Boulder, CO (US); Thomas Kooh, Boulder, CO (US); Kent S. Norgren, Louisville, CO (US); Stephen G. Price, Longmont, CO (US); Kenneth S. Shouldice, Firestone, CO (US)

(21) Appl. No.: 13/036,254

(22) Filed: Feb. 28, 2011

(51) Int. Cl. G06F 15/00

(52) U.S. Cl. 358/1.15

(57) ABSTRACT

Methods and systems are provided for temporarily modifying how a printer utilizing media-based scheduling handles jobs that are forced to print. In one embodiment, a print controller marks print jobs as eligible to print that have a media type corresponding to media loaded at the printer. Printing of the eligible print jobs is initiated, and a request to print an ineligible print job is received by the print controller. The print controller temporarily marks the eligible print jobs as ineligible, indicates a change to the media loaded at the printer to a media type for the requested print jobs, and initiates printing of the requested print job. Upon completion of printing, the print controller indicates a change back to the media previously loaded at the printer, and then restores the eligibility of the print jobs temporarily marked as ineligible to resume printing of the eligible print jobs.

### FIELD OF THE INVENTION

The invention relates to the field of printing systems and, in particular, to temporarily modifying how a media-based scheduling system of a printer handles jobs that are forced to print.

### BACKGROUND

Printers typically queue up jobs based on an order in which they were received by the printer. This is known as a First In First Out (FIFO) scheduling system. For example, if job A is received first, job B is received second, and job C is received third, then the printer queues or schedules job A to print before job B, and schedules job C after job B in FIFO scheduling. In some cases, this may be undesirable, as the jobs may require different media types in order to print. In a strict FIFO order, the print operator may be tasked with a number of media changes in order to print the queued jobs. In the example, consider that jobs A and C are letter jobs, and job B is an A4 job. In a FIFO scheduling system, the print operator may be tasked with removing letter media from the printer after job A prints, and then inserting A4 media in the printer to allow Job B to print. However, job C is another letter job. The print operator may then have to remove the A4 media after job B prints, and re-insert letter media to allow job C to print. This results in a number of unnecessary media changes at the printer.

These problems may be solved by marking some jobs as eligible to print and some jobs as ineligible to print based on the media that is loaded at the printer. In the example, a printer currently loaded with letter paper marks jobs A and C as eligible to print with media-based scheduling. Job B is marked as ineligible to print. The jobs A and C print, and job B is held until A4 media is loaded at the printer. As new letter jobs are received at the printer, the letter jobs are marked as eligible and allowed to print because letter media is currently loaded at the printer. As jobs are received that do not match the media loaded at the printer, the jobs are marked as ineligible to print and held. When media is changed at the printer, jobs in the queue are re-evaluated. Jobs that match the media now loaded at the printer are marked as eligible to print. Jobs that do not match the media loaded at the printer are marked as ineligible to print. Media-based scheduling allows the printer to continue to print without interventions (e.g., media changes) by a print operator. In some cases, however, one or more of the currently ineligible jobs may be needed sooner than the queued eligible jobs. The printer handles this case by allowing the print operator to select an ineligible job and force it to print next.

Problems may arise when jobs are forced to print that are currently marked as ineligible, as a media change to allow the ineligible job to print causes a re-evaluation of the eligibility of jobs in the queue. Some jobs may then begin printing based on the change to the media in the printer. This makes the print operator's job harder, as forcing jobs to print in such a system results in ambiguity about which jobs should be printed after the media change.

### SUMMARY

Embodiments described herein provide for temporarily modifying how a printer using media-based scheduling handles jobs that are forced to print. When a printer uses media-based scheduling, jobs in a queue for the printer are marked as eligible to print when a media type specified for the jobs corresponds to a media loaded at the printer. When a request is received to force a job to print that does not match the media loaded at the printer, the eligible jobs are temporarily marked as ineligible. The media loaded at the printer is changed to the media type of requested job, and the requested job is printed. After the requested job is printed, the media loaded at the printer is changed back to the media type that was loaded at the printer before the media change. Jobs that were temporarily marked as ineligible are now marked as eligible to print, and therefore resume printing. This allows a job having a different media type than the media loaded at the printer to print without permanently affecting the eligibility of other print jobs in the queue due to the change in media.

In one embodiment, a print controller for a printer includes a queue and a control system. The queue stores print jobs that are scheduled for the printer. The control system marks print jobs in the queue as eligible to print that have a media type that corresponds to media loaded at the printer. The control system initiates printing of the eligible print jobs. The control system receives a request to print an ineligible print job, and temporarily marks the eligible print jobs in the queue as ineligible. The control system indicates a change to the media loaded at the printer to a media type for the requested print job, and initiates printing of the requested print job in response to the media change. Upon completion of the requested print job, the control system indicates a change back to the media previously loaded at the printer. The control system then restores the eligibility of the print jobs temporarily marked as ineligible to resume printing of the eligible print jobs.

Other exemplary embodiments may be described below.

### DESCRIPTION OF THE DRAWINGS

Some embodiments of the present invention are now described, by way of example only, and with reference to the accompanying drawings. The same reference number represents the same element or the same type of element on all drawings.

FIG. 1 is a block diagram illustrating a printing system in an exemplary embodiment.

FIG. 2 is a flow chart illustrating a method of temporarily modifying print eligibility for print jobs in an exemplary embodiment.

FIG. 3 is an example of how print jobs may be marked as eligible to print by control system 106 in an exemplary embodiment.

FIGS. 4-8 illustrate how a print job may be forced to print in a media-based scheduling system in an exemplary embodiment.

FIG. 9 illustrates a computer system operable to execute computer readable medium embodying programmed instructions to perform desired functions in an exemplary embodiment.

### DESCRIPTION OF THE EMBODIMENTS

The figures and the following description illustrate specific exemplary embodiments of the invention. It will thus be appreciated that those skilled in the art will be able to devise various arrangements that, although not explicitly described or shown herein, embody the principles of the invention and are included within the scope of the invention. Furthermore, any examples described herein are intended to aid in understanding the principles of the invention, and are to be construed as being without limitation to such specifically recited examples and conditions. As a result, the invention is not limited to the specific embodiments or examples described below, but by the claims and their equivalents.

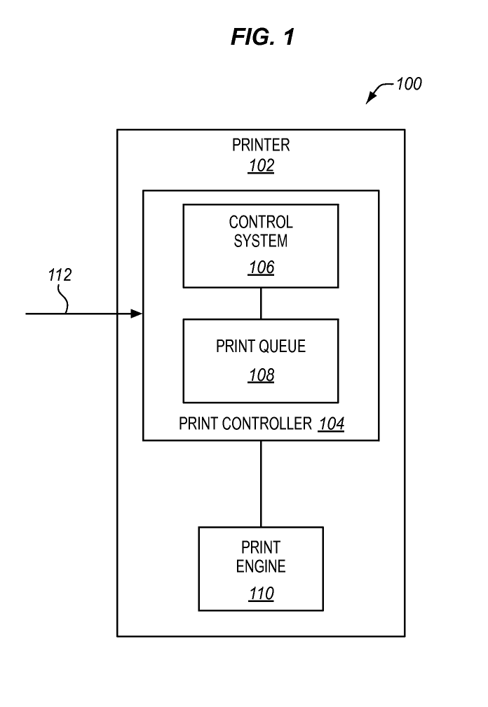

FIG. 1 is a block diagram illustrating a printing system 100 in an exemplary embodiment. System 100 includes a printer 102 that prints to media, such as paper. The media may be continuous form media, cut sheet media, etc.

Printer 102 includes a print controller 104. Print controller 104 receives print data 112 from a host/client system (not shown) and rasterizes print data 112 into bitmap data for print engine 110. Print engine 110 imprints the rasterized data to the media.

In this embodiment, print controller 104 temporarily modifies print eligibility for print jobs when a job is forced to print. When printer 102 uses media-based scheduling, jobs in a queue 108 for printer 102 are marked as eligible to print when a media type specified for the jobs corresponds to a media loaded at printer 102. Problems may arise when a job is forced to print that uses a different media type than what is loaded at printer 102. When a media is changed at printer 102 to allow the forced job to print, media-based scheduling would suggest modifying the eligibility of jobs in queue 108 based on the new media loaded at printer 102. However, this may cause problems when jobs are printed out of an expected order based on their previous eligibility status.

Print controller 104 solves these and other related problems in media-based scheduling by temporarily marking eligible jobs as ineligible when a request is received to force a job to print. After printing the forced job, print controller 104 restores the eligibility of the print jobs temporarily marked as ineligible to resume printing of the jobs.

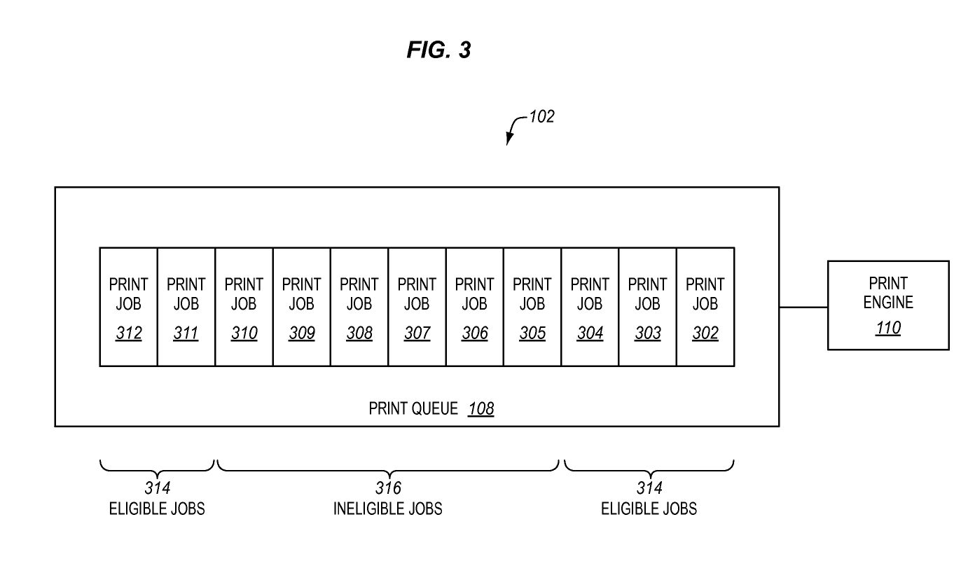

In this embodiment, print controller 104 includes a control system 106 and print queue 108. Generally, print queue 108 stores print jobs that are scheduled for printer 102. Details about how control system 106 may operate are shown in more detail with respect to FIGS. 3-8.

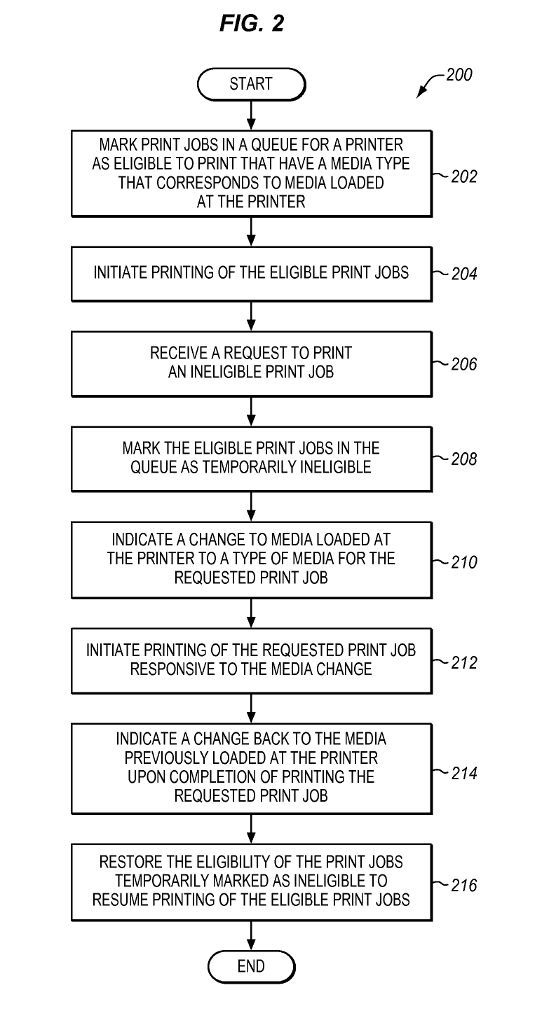

FIG. 2 is a flow chart illustrating a method 200 of temporarily modifying print eligibility for print jobs in an exemplary embodiment. The steps of method 200 will be described with respect to print controller 104 of FIG. 1, although one skilled in the art will understand that method 200 may be performed by other systems not shown. The steps of method 200 described herein are not all inclusive and may include other steps not shown. The steps for the flow charts shown herein may also be performed in an alternative order.

In step 202, control system 106 of print controller 104 marks print jobs in queue 108 for printer 102 as eligible to print that have a media type that corresponds to a media type for printer 102. FIG. 3 is an example of how print jobs may be marked as eligible to print by control system 106 in an exemplary embodiment. In this embodiment, print jobs 302-304 and 311-312 have a media type that corresponds with a type of media currently loaded at printer 102. Thus, print jobs 302-304 and 311-312 are marked as eligible jobs 314. Print jobs 305-310 in this embodiment do not have a media type that corresponds with the type of media currently loaded at printer 102. Thus, print jobs 305-310 are marked as ineligible jobs 316.

In step 204, control system 106 initiates printing of jobs marked as eligible. During printing, jobs marked as eligible may be printed and removed from queue 108. Generally, jobs marked as eligible are printed in an order from the front of queue 108 to the back of queue 108. In FIG. 3, print job 302 is at the front of queue 108 and therefore, will print first. Print job is 303 is next to print after print jobs 302. Print job 304 will print third. Print jobs 305-310, however, are marked as ineligible. Therefore, print jobs 305-310 will be held from printing until the media loaded at printer 102 changes to correspond with the media type of print jobs 305-310.

While printing jobs 302-304 and 311-312, control system 106 receives a request to print a job that is marked ineligible (step 206 of FIG. 2). For example, control system 106 may receive a request to force job 308 to print, which is marked as ineligible. Control system 106 then marks eligible print jobs 302-304 and 311-312 as temporarily ineligible (step 208 of FIG. 2). In step 210, control system 106 indicates a change to the media loaded at printer 102 to a type of media for the requested job. In continuing with the example, a request is received to force print job 308 to print. However, print job 308 does not have a media type that corresponds with the media currently loaded at printer 102. Thus, control system 106 indicates a change to the media loaded at printer to correspond with a media type for the requested job. Control system 106 may indicate the media change to a print operator using a graphical user interface of printer 102 (not shown).

In step 212, control system 106 initiates printing of the requested job (e.g., print job 308) after the media change has been performed at printer 102. Control system 106 may also temporarily mark the requested job as eligible in response to the media change, and/or temporarily mark other jobs as ineligible responsive to the media change. Although the other jobs may have a media type that corresponds to the media type for the requested job, the other jobs are marked as ineligible. This allows the requested job to print while holding the other jobs, even though they may have a media type that corresponds to the media loaded at printer 102 after the media change. Control system 106 may receive a notification from the print operator using a graphical user interface of printer 102 (not shown), or may query a paper handling system (not shown) of printer 102 to determine if the media loaded at printer 102 has changed.

In step 212, control system 106 initiates printing of the requested job after the media has been changed at printer 102 to a media type corresponding with the requested job. In continuing with the example, control system 106 initiates printing of print job 308. After the requested job completes printing, control system 106 indicates a change back to the media previously loaded at printer 102 (step 214).

When the media is changed back to the previous media type after printing the requested job, control system 106 restores the eligibility of the print jobs temporarily marked as ineligible to resume printing of the eligible jobs. In FIG. 3, print jobs 302-304 and 311-312 are temporarily marked as ineligible in step 208. Therefore, print jobs 302-304 and 311-312 will be restored to their previously eligible status, and printing will resume for print jobs 302-304 and 311-312.

In a media-based scheduling system, forcing a job to print that includes a media change at printer 102 may result in problems when jobs are printed out of an expected order based on their previous eligibility status. By temporarily marking print jobs as ineligible when a request is received to force a job to print, printer 102 handles the request in a predictable and consistent manner, improving the performance of a media-based scheduling system.

### EXAMPLE

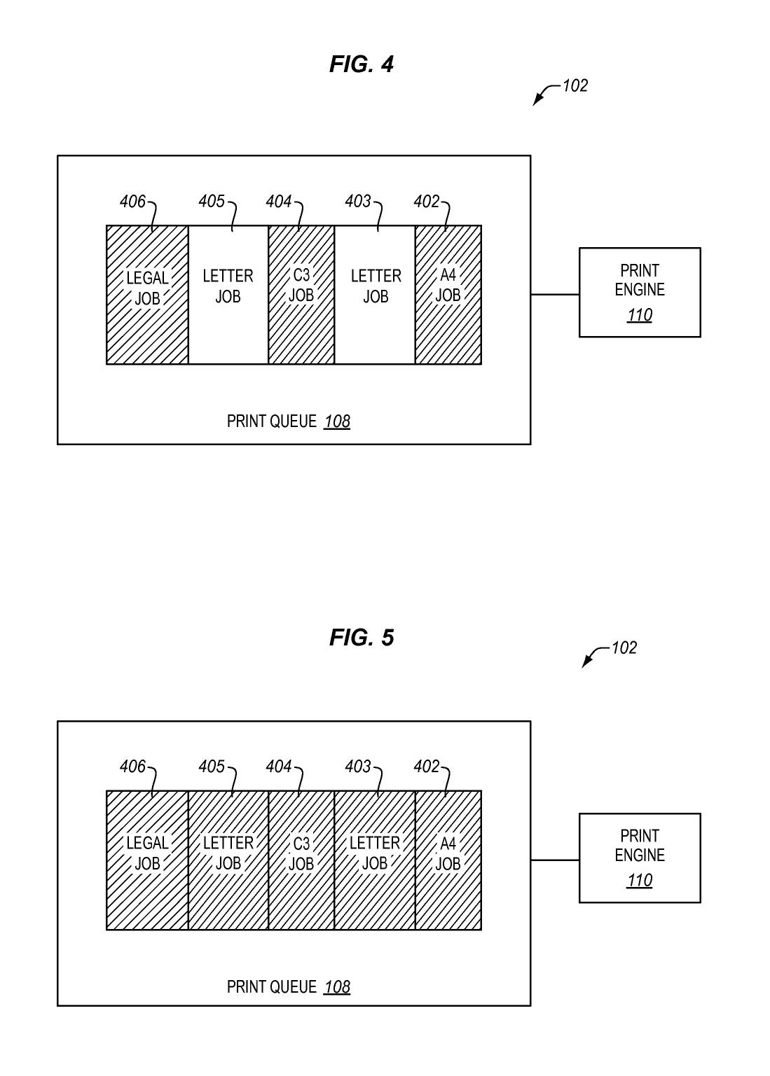

Consider the following example whereby printer 102 is currently loaded with letter media. FIGS. 4-8 illustrate how a print job may be forced to print in a media-based scheduling system in an exemplary embodiment. Print controller 104 analyzes print jobs 402-406 in queue 108, and marks print jobs 403 and 405 as eligible to print (see FIG. 4). Eligible jobs in queue 108 are marked in white. Ineligible jobs in queue 108 are marked with a fill pattern. Print controller 104 initiates printing of the eligible print jobs 403 and 405. While printing jobs 403 and 405, print controller 104 receives a request to force print job 404 to print. Print job 404 is currently marked as ineligible to print because the job is a C3 media job, and printer 102 is not currently loaded with C3 media. Printer 102 at the time of the request is loaded with letter paper. In response to receiving a request to force job 404 to print, print controller 104 temporarily marks some jobs ineligible to print based on the change to the media loaded at printer 102. In the example, the letter media is changed to C3 media. Thus, print jobs 403 and 405 are temporarily marked as ineligible, as print jobs 403 and 405 are letter jobs. This is illustrated in FIG. 5.

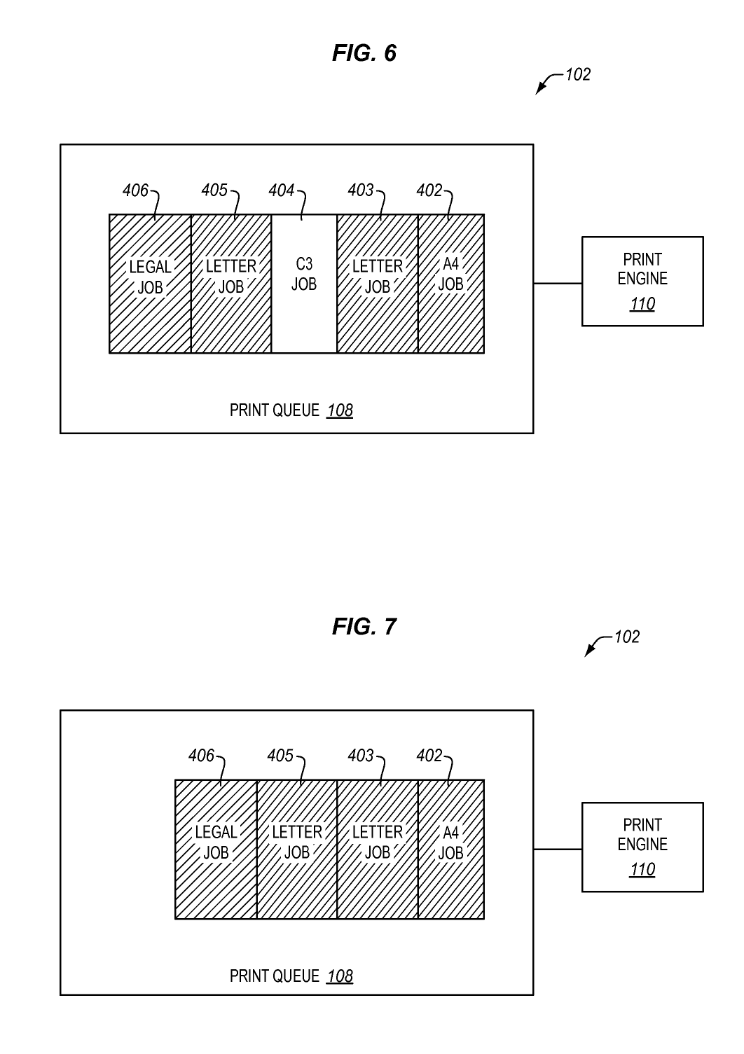

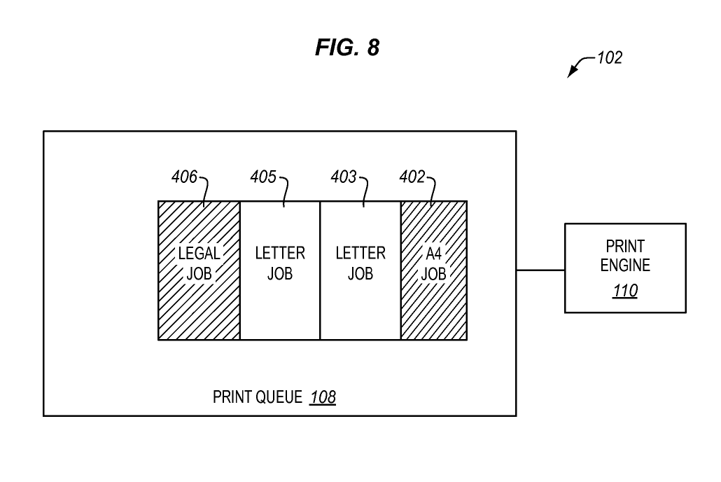

In continuing with the example, print controller 104 marks print job 404 as eligible to print after the tray holding letter media is changed to C3 media. Other print jobs 402-403 and 405-406 are temporarily marked as ineligible. This is illustrated in FIG. 6. Print controller 104 initiates printing of print job 404, and print job 404 is printed. This is illustrated in FIG. 7, where print job 404 is printed and removed from queue 108. Print controller 104 then indicates a change back to the letter media previously loaded at printer 102. Thus, the C3 media currently loaded at printer 102 is replace with letter media. After the media change back to the letter media, print controller 104 restores the eligibility of print jobs 403 and 405, as these jobs were temporarily marked as ineligible while print job 404 was forced to print. This is illustrated in FIG. 8. Generally, print controller 104 may re-evaluate jobs 402-406 after a media change at printer 102 to determine which of jobs 402-406 have media type that correspond with the media type loaded at printer 102. Jobs that have a corresponding media type are marked as eligible to print.

In some cases, there may be an option to switch printer 102 between normal media based scheduling and temporarily modifying the eligibility of jobs as discussed herein (e.g., by allowing a print operator to switch modes used by printer 102 when a job is forced to print). In one mode, printer 102 may generally operate using media based scheduling rules such that jobs having a type of media that corresponds to the forced job print (e.g., are made eligible) along with the forced job. In another mode, printer 102 may operate in accordance with method 200. Also, printer 102 may operate in an intermediate mode between the two. For example, printer 102, after printing the forced job, may print some jobs (e.g., make some job eligible) in queue 108 that have a type of media that corresponds with the type of media of the forced job. A print operator may select some jobs in queue 108 that will print after the media change, in addition to the forced job. This provides more flexibility in handling the jobs in queue 108 will print when the media loaded at printer 102 changes to correspond with the forced job.

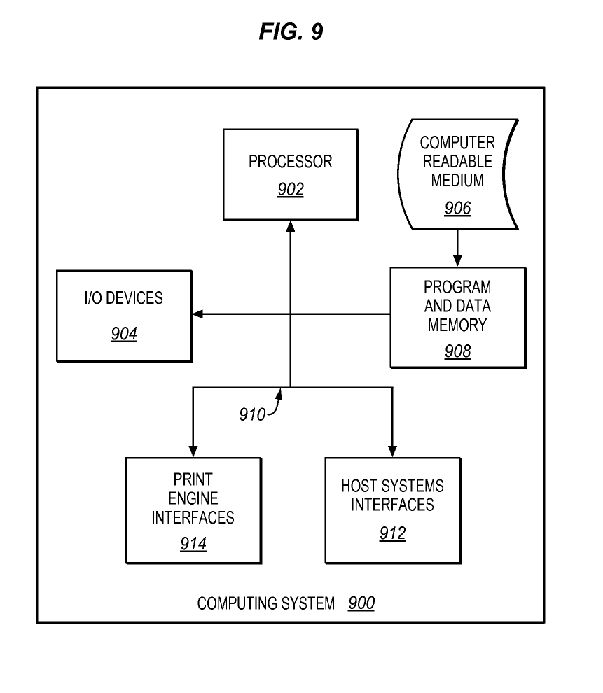

The invention can take the form of an entirely hardware embodiment, an entirely software embodiment or an embodiment containing both hardware and software elements. In one embodiment, the invention is implemented in software, which includes but is not limited to firmware, resident software, microcode, etc. FIG. 9 illustrates a computing system 900 in which a computer readable medium 906 may provide instructions for performing method 200 in an exemplary embodiment.

Furthermore, the invention can take the form of a computer program product accessible from a computer-usable or computer-readable medium 906 providing program code for use by or in connection with a computer or any instruction execution system. For the purposes of this description, a computer-usable or computer readable medium 906 can be any apparatus that can contain, store, communicate, propagate, or transport the program for use by or in connection with the instruction execution system, apparatus, or device.

The medium 906 can be an electronic, magnetic, optical, electromagnetic, infrared, or semiconductor system (or apparatus or device) or a propagation medium. Examples of a computer-readable medium 906 include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code includes at least one processor 902 coupled directly or indirectly to memory 908 through a system bus 910. The memory 908 can include local memory employed during actual execution of the program code, bulk storage, and cache memories which provide temporary storage of at least some program code in order to reduce the number of times code is retrieved from bulk storage during execution.

Input/output or I/O devices 904 (including but not limited to keyboards, displays, pointing devices, etc.) can be coupled to the system either directly or through intervening I/O controllers.

Network adapters may also be coupled to the system to enable the data processing system to become coupled to other data processing systems, such a through host systems interfaces 912, or remote printers or storage devices through intervening private or public networks, such as through print engine interfaces 914. Modems, cable modem and Ethernet cards are just a few of the currently available types of network adapters.

Although specific embodiments were described herein, the scope of the invention is not limited to those specific embodiments. The scope of the invention is defined by the following claims and any equivalents thereof

We claim:

1. A print controller for a printer, the print controller comprising:
a queue operable to store print jobs scheduled for the printer; and
a control system operable to mark print jobs in the queue as eligible to print that have a media type that corresponds to media loaded at the printer, and to initiate printing of the eligible print jobs,
the control system is further operable to receive a request to print an ineligible print job, to temporarily mark the eligible print jobs in the queue as ineligible, to indicate a change to the media loaded at the printer to a media type for the requested print job, to initiate printing of the requested print job responsive to the media change, to indicate a change back to the media previously loaded at the printer upon completion of printing the requested print job, and to restore the eligibility of the print jobs temporarily marked as ineligible to resume printing of the eligible print jobs.

2. The print controller of claim 1 wherein:
the control system is further operable to mark the requested print job as temporarily eligible responsive to the media change.

3. The print controller of claim 1 wherein:
the control system is further operable to identify other print jobs in the queue that have a media type that corresponds with the media type for the requested print job, and to temporarily mark the other print jobs as ineligible responsive to the media change.

4. The print controller of claim 1 wherein:
the control system is further operable to restore the eligibility of the print jobs temporarily marked as ineligible responsive to the change back to the media previously loaded at the printer.

5. The print controller of claim 1 wherein:
the print controller is further operable to provide a notification on a graphical user interface of the printer to indicate a change to the media loaded at the printer, and to receive a notification from the graphical user interface indicating that the media loaded at the printer has changed.

6. The print controller of claim 1 wherein:
the print controller is further operable to query a paper handling system of the printer to determine that the media loaded at the printer has changed.

7. A method comprising:
marking print jobs in a queue for a printer as eligible to print that have a media type that corresponds to media loaded at the printer;
initiate printing of the eligible print jobs;
receiving a request to print an ineligible print job;
marking the eligible print jobs in the queue as temporarily ineligible;
indicating a change to the media loaded at the printer to a media type for the requested print job;
initiate printing of the requested print job responsive to the media change;
indicating a change back to the media previously loaded at the printer upon completion of printing the requested print job; and
restoring eligibility of the print jobs marked as temporarily ineligible to resume printing of the eligible print jobs.

8. The method of claim 7 further comprising:
marking the requested print jobs as temporarily eligible responsive to the media change.

9. The method of claim 7 further comprising:
identifying other print jobs in the queue that have a media type that corresponds with the media type for the requested print job; and
marking the other print jobs as temporarily ineligible responsive to the media change.

10. The method of claim 7 wherein restoring the eligibility further comprises:
restoring the eligibility of the print jobs temporarily marked as ineligible responsive to the change back to the media previously loaded at the printer.

11. The method of claim 7 further comprising:
providing a notification on a graphical user interface of the printer to indicate a change to the media loaded at the printer; and
receiving a notification from the graphical user interface indicating that the media loaded at the printer has changed.

12. The method of claim 7 further comprising:
querying a paper handling system of the printer to determine that the media loaded at the printer has changed.

13. A tangible computer readable medium including programmed instructions which, when executed by a processor, are operable for performing a method of temporarily modifying print eligibility for print jobs, the method comprising:
marking print jobs in a queue for a printer as eligible to print that have a media type that corresponds to media loaded at the printer;
initiate printing of the eligible print jobs;
receiving a request to print an ineligible print job;
marking the eligible print jobs in the queue as temporarily ineligible;
indicating a change to the media loaded at the printer to a media type for the requested print job;
initiate printing of the requested print job responsive to the media change;
indicating a change back to the media previously loaded at the printer upon completion of printing the requested print job; and
restoring eligibility of the print jobs marked as temporarily ineligible to resume printing of the eligible print jobs.

14. The medium of claim 13 wherein the method further comprises:
marking the requested print jobs as temporarily eligible responsive to the media change.

15. The medium of claim 13 wherein the method further comprises:
identifying other print jobs in the queue that have a media type that corresponds with the media type for the requested print job; and
marking the other print jobs as temporarily ineligible responsive to the media change.

16. The medium of claim 13 wherein restoring the eligibility further comprises:
restoring the eligibility of the print jobs temporarily marked as ineligible responsive to the change back to the media previously loaded at the printer.

17. The medium of claim 13 wherein the method further comprises:
providing a notification on a graphical user interface of the printer to indicate a change to the media loaded at the printer; and
receiving a notification from the graphical user interface indicating that the media loaded at the printer has changed.

18. The medium claim 13 wherein the method further comprises:
querying a paper handling system of the printer to determine that the media loaded at the printer has changed.
